(19) United States
(12) Patent Application Publication
(10) Pub. No.: US 2015/0222332 A1
(43) Pub. Date: Aug. 6, 2015

(54) Method of Cooperative Emission, Signal, Source Entity, Relay Entity, Method of Reception, Destination Entity, System and Computer Program Corresponding Thereto

(71) Applicants: CNRS - Centre National De La Recherche Scientifique, Paris Cedex 16 (FR); INSA - Institut National De Sciences Appliquees, Rennes (FR)

(72) Inventors: Jean-Francois Helard, Rennes (FR); Maryline Helard, Rennes (FR); Mathieu Crussiere, Laille (FR); Roua Youssef, Rennes (FR)

(21) Appl. No.: 14/425,555

(22) PCT Filed: Sep. 3, 2013
(86) PCT No.: PCT/EP2013/068155

§ 371 Date: Mar. 3, 2015

(30) Foreign Application Priority Data
Sep. 3, 2012 (FR) 1258203

(51) Int. Cl. H04B 7/02; H04L 25/03; H04L 1/00; H04L 27/34

(52) U.S. Cl. CPC H04B 7/024; H04L 27/3444; H04L 25/03286; H04L 1/005; H04L 2001/0097

(57) ABSTRACT

A method is provided for transmitting an information sequence from a source entity to a recipient entity, via at least one relay entity. The method includes: transmitting, by said source entity, modulated symbols representative of said information sequence, obtained after modulation of said information sequence, on a first channel, called ‘source’ modulated symbols; and transmitting, by said at least one relay entity, modulated symbols representative of said information sequence, obtained after modulation of an estimation of said information sequence on a second channel, called ‘relay’ modulated symbols, said first and second channels being orthogonal between each other. The source entity and the at least one relay entity simultaneously send at least one of said ‘source’ modulated symbols and at least one of said ‘relay’ modulated symbols.

### CROSS-REFERENCE TO RELATED APPLICATIONS

This Application is a Section 371 National Stage Application of International Application No. PCT/EP2013/068155, filed Sep. 3, 2013, the content of which is incorporated herein by reference in its entirety, and published as WO 2014/033315 on Mar. 6, 2014, not in English.

### DOMAIN OF THE INVENTION

The domain of the invention is that of digital communications, in transmission or broadcast. More specifically, the invention relates to the transmission of coded data, from at least one source entity to at least one destination entity.

In particular, the invention relates to the improvement of the quality of the transmission of such data, by mean of cooperative communications based on the use of one or more relays to improve communications between the source entity or entities and the recipient entity or entities.

### PRIOR ART

Since the 1970s, use has been made of a method implementing a relay transmission channel to make the communications reliable. This method can improve the transmission efficiency. The relay can either decode and forward the bitstream (“Decode & Forward”) or amplify and forward the signal received (“Amplify & Forward”) or again compress and forward the signal received.

M. Valenti and B. Zhao (“Distributed turbo codes: towards the capacity of the relay channel”, Vehicular Technology conference, vol. 1, pp. 322-326, October 2003) notably propose a new coding method known as distributed turbo code. According to this approach, a unique source sends data to the relays and the recipient terminal. The relay decodes, interleaves and recodes the message before retransmitting it to the recipient. In other words, the relay carries out one of the turbo coding steps, generally carried out by the emitter (which justifies the term of distributed “turbo-code”). The recipient entity thus receives two coded versions of the original message and decodes them jointly by using an iterative decoding algorithm. This method thus creates an improvement in gain and diversity.

More recently, R. Thobaben (‘On distributed codes with noisy relays’, Proc. Asilomar Conference on Signals, Systems, and Computers, October 2008), and Z. SI, R. Thobaben and M. Skoglund (‘On distributed serially concatenated codes’ Proc IEEE signal processing workshop on Signal Processing Advance in Wireless communications (SPAWC), June 2009) notably use the previous technology by improving it to take into account respectively the presence of transmission noise and serially concatenated distributed codes.

Further, the document US 2008/0317168 also divulged a method implementing a relay transmission channel, in particular a “half-duplex” relay enabling an alternative communication either according to an uplink, or downlink, is considered.

According to these different methods, the transmission is made in accordance with FIG. 1. More precisely, the transmission time is divided into two units: the first unit of time is devoted to the transmission of the source to the relay, whereas the second unit of time is allocated to the relay.

Another method based on a superposed modulation between two users is proposed by E. Larsson and B. Vojcic (‘Cooperative transmit diversity based on superposition modulation’, IEEE Communications Letters, pp. 778-780, 2005). According to this method, each user transmits a superposition of its information and the information received from their partner, which also requires two units of time for the transmission owing to the fact that there are two users.

Such an alternative transmission on two units of time is not optimum in terms of spectral efficiency.

Indeed, the efficiency of this type of method is particularly illustrated by the following relation:

$$min \{ \frac{1}{2 C ( {γ}_{sr} )} , \frac{1}{2 C ( {γ}_{rd} )} , \frac{1}{2 C ( {γ}_{sd} )} \}$$

where:
the signal-to-noise ratio of the source-destination channel, source-relay, and relay-destination, respectively.

However, if the source and relay transmit simultaneously this equation becomes:

min{C(γₛᵣ),C(γ_{rd})+C(γ_{rd})}

Hence, the methods of the prior art previously described have an efficiency twice as low in comparison with methods based on a simultaneous transmission of the source and the relay to the recipient.

Further, when the source and the relay transmit simultaneously, the signals interfere on reception which makes their separation and their recovery very difficult and complex.

There is thus a need for a new relay transmission method enabling on the one hand the transmission spectral efficiency to be increased, and further enabling the interferences and processing complexity to be reduced during reception by a recipient entity.

### SUMMARY OF THE INVENTION

The invention proposes a new solution that does not present all these disadvantages of the prior art, in the form of a transmission method from at least one source entity to a recipient entity, via at least one relay entity,

According to the invention, such a method comprises:
a transmission step, by the at least one source entity, of modulated symbols representative of the information sequence, called ‘source’ modulated symbols, each ‘source’ modulated symbol corresponding to a point of a first constellation, of order n.
a transmission step, by said at least one relay entity, of modulated symbols representative of an estimation of said information sequence, called ‘relay’ modulated symbols, each ‘relay’ modulated symbol corresponding to a point of a second constellation, of order m. the points of the first and second constellations all being separate,
   Further, according to the method according to the invention, the at least one source entity and the at least one relay entity simultaneously send at least one of the ‘source’ modulated symbols and at least one of said ‘relay’ modulated symbols.

The invention thus proposes a new cooperative transmission method implementing at least one relay entity, enabling the spectral efficiency of the methods of the prior art to be improved owing to the fact that they implement a specific simultaneous transmission of a source entity and a relay entity.

Multiple source and/or multiple relay systems can naturally be transposed from the method according to the invention set out above. Subsequently, in order to simplify the description, a transmission system comprising a source entity and a relay entity is most frequently considered. The case of a multiple relay system comprising two relay entities will be described in detail subsequently within the description of an embodiment of the invention.

Indeed, according to the invention, the source entity and the relay entity simultaneously transmit two types of symbols, the ‘source’ modulated symbols and the ‘relay’ modulated symbols. A ‘source’ modulated symbol corresponds to a point of a first constellation of order n, and a ‘relay’ modulated symbol corresponds to a point of a second constellation of order m.

More precisely, according to the invention the representative point of a ‘source’ modulated symbol is separate from the representative point of a ‘relay’ symbol. Such a distinction between the ‘relay’ modulated symbols and the ‘source’ modulated symbols advantageously enables interferences to be overcome owing to the fact that it is possible on reception to determine the symbols coming respectively from the source entity and the relay entity.

Indeed, seen from the receiver, a symbol resulting from the simultaneous transmission of a ‘source’ modulated symbol and a ‘relay’ modulated symbol corresponds to a point of a constellation of order n+m (comprising 2^{n+m} separate points), whose real component is obtained by summation of the real components of points associated with the ‘source’ modulated symbol and the ‘relay’ modulated symbol and whose imaginary component is obtained by summation of the imaginary components of the points associated with the ‘source’ modulated symbol and the ‘relay’ modulated symbol. Through a choice of the ‘source’ and ‘relay constellations providing the uniqueness of the coordinates of each point of the resulting constellation of order n+m, it is thus possible at the receiver level to dissociate the original ‘source’ and ‘relay’ modulated symbols without interference.

The simultaneous transmission of the source entity and the relay entity to the recipient thus enables the spectral efficiency to be increased owing to the fact that the recipient entity receives a piece of modulated information in a distributed manner between the source entity and the relay entity.

According to a particular aspect, the transmission step of ‘source’ modulated symbols comprises a sub-step for coding the information sequence, supplying at least one ‘source’ code word, and a sub-step for modulating the at least one ‘source’ code word, supplying the ‘source’ modulated symbols.

Further, the transmission step of ‘relay’ modulated symbols comprises a sub-step for decoding ‘source’ modulated symbols, supplying an estimation of the information sequence, a sub-step for coding the estimated information sequence, supplying at least one ‘relay’ code word, and a sub-step for modulating the at least one ‘relay’ code word, supplying said ‘relay’ modulated symbols.

Hence, each transmission step implemented by the relay entity and the source entity respectively comprises a coding step and a modulation step.

Further, according to the invention, there is an offset of one unit of time between the source entity and relay entity owing to the fact that the relay entity receives and decodes the information sent by the source entity before coding it in turn and sending it at the same time as the source entity during a second unit of time.

Hence, the same information, possibly coded and/or modulated differently by the relay entity and the source entity, is sent once by the relay entity and the source entity with a temporal offset of one unit, the relay entity sending a first information item when the source entity sends at the same time a second information item which it will then process.

The relay entity and the source entity thus sending simultaneously but with a temporal offset for a single information item.

Advantageously, the sub-steps for coding the information sequence and for coding the estimation of the estimated information sequence implement separate coding methods.

Hence, the method according to the invention is characterised by a great degree of flexibility in implementation. Indeed, the source entity and the relay entity can implement separate or even identical coding, which enables many combinations of source entity and relay entity.

Further, according to this aspect, it is possible to combine source entities and existing relay entities can import the coding that they implement respectively. According to another aspect of the invention, the sub-steps for modulating the at least one ‘source’ code word and for modulating the at least one ‘relay’ code word use separate modulation methods. This aspect is particularly advantageous owing to the fact that it enables a great degree of flexibility in implementing the invention.

Indeed, the source entity can for example implement a modulation represented by a constellation of order n=1, for example a BPSK, whereas the relay entity implements a modulation represented by a constellation of order m=2, for example a QPSK, the points of the two constellations of these two modulations all being separate.

The resulting constellation of the signal from the simultaneous transmission of the source entity and the relay entity, respectively a ‘source’ modulated symbol and ‘relay’ modulated symbol corresponds to a constellation of order m+n.

Hence, if use is made of the two examples of constellations cited above, a constellation of order m+n=3 comprising eight points is obtained.

The real component of a point of this resulting constellation is obtained by summation of a point of the real components of the points associated with the ‘source’ modulated symbol and the ‘relay’ modulated symbol whereas the imaginary component is obtained by summation of the imaginary components of the points associated with the source modulated symbol and the ‘relay’ modulated symbol.

Hence, it is possible to combine source entities and existing relay entities can import the modulation that they implement respectively, from the moment that the constellations associated respectively with the source entity and the relay entity have entirely separate points.

Further, it is naturally possible to use the same modulation in the source entity and in the relay entity owing to the fact that advantageously the points of the constellation implemented by the source entity and the points of the constellation implemented by the relay entity are separate owing to the fact that in the case of identical modulations a rotation (e^{jφ}) is implemented between the relay entity and the source entity. Likewise, it is also possible to advantageously apply different amplitude weighting factors between the relay entity and the source entity, so that the points of the constellations implemented by the source entity and the relay entity are separate, other than by a rotation operation.

According to a particular embodiment, the sub-steps for modulating the at least one ‘source’ code word and for modulating the at least one ‘relay’ code word are respectively quadrature and phase modulations.

According to this particular embodiment, the ‘source’ and ‘relay’ modulated symbols are therefore orthogonal. Each point of the first constellation of order n used by the ‘source’ entity being placed on an orthogonal direction to that of a point of the second constellation of order m used by the ‘relay’ entity.

This example based on the orthogonality of the constellations implemented by the source entity and by the relay entity is not restrictive. Indeed, according to the invention it is possible to use any non-null rotation and different from 2π (modulo 2) of a constellation implemented by the source entity in relation to the one implemented by the relay entity.

Another aspect of the invention also relates to a representative signal of an information sequence, sent by a source entity to a recipient entity, via at least one relay entity, according to the transmission method described above.

According to this embodiment, such a signal comprises at least one symbol resulting from the simultaneous transmission of a ‘source’ modulated symbol by the source entity and a ‘relay’ modulated symbol by the relay entity,

the ‘source’ modulated symbol corresponding to a point of a first constellation of order n,
the ‘relay’ modulated symbol corresponding to a point of a second constellation of order m,
the points of the first and second constellations all being separate,
the resulting symbol corresponding to a point of a constellation of order n+m, whose real component is obtained by summation of the real components of the points associated with the ‘source’ modulated symbol and the ‘relay’ modulated symbol and whose imaginary component is obtained by summation of the imaginary components of the points associated with the ‘source’ modulated symbol and the ‘relay’ modulated symbol.

Hence, in the resulting signal of the simultaneous emissions of the relay entity and source entity, according to the invention to at least one symbol is transmitted corresponding to a point of a constellation of a higher order associated with the first and second constellations of the source entity and relay entity.

Owing to the fact that the points of the first and second constellations are all separate, it is possible to easily separate on reception the two ‘superposed’ constellations in the constellation of a higher order of the signal.

This signal can be transmitted and/or stored on a data support. This signal can naturally comprise the different characteristics relating to the transmission method according to the invention.

In another embodiment, the invention relates to a source entity able to transmit an information sequence to a recipient entity, via at least one relay entity.

According to the invention, such a source entity comprises transmission means of modulated symbols representative of the information sequence, called ‘source’ modulated symbols, each ‘source’ modulated symbol corresponding to a point of a first constellation; the transmission means being configured to send at least one of the ‘source’ modulated symbols simultaneously to at least one ‘relay’ modulated symbol representative of an estimation of the information sequence, each ‘relay’ modulated symbol corresponding to a point of a second constellation, the points of the first and second constellations all being separate.

In another embodiment, the invention relates to a relay entity able to receive, a source entity, at least one ‘source’ modulated symbol representative of an information sequence, each ‘source’ modulated symbol corresponding to a point of a first constellation, and to re-send the information sequence to a remote entity.

According to the invention, such a relay entity comprises transmission means of ‘relay’ modulated symbols representative of an estimation of the information sequence, each ‘relay’ modulated symbol corresponding to a point of a second constellation, the transmission means being configured to send at least one of the ‘relay’ modulated symbols simultaneously to at least one of the ‘source’ modulated symbols, the points of said first and second constellations all being separate.

Such a source entity and such a relay entity are notably able to co-operate to implement the transmission method described previously. Hence, the advantages and embodiment described previously with regard to the method according to the invention are also applicable to each of these entities.

According to the invention, it is possible to use a standard relay entity. In this case, the implementation of the invention consists in modifying the source entity so that the points of the constellations used respectively by the source entity and the relay entity are all separate.

Reciprocally, it is possible to use a standard source entity. In this case, the implementation of the invention consists in modifying the relay entity so that the points of the constellations used respectively by the source entity and the relay entity are all separate.

In another embodiment, the invention relates to a method for receiving a signal representative of an information sequence, sent by an entity, via at least one relay entity.

According to the invention, such a reception method comprises:
a step for receiving the signal comprising, at least one symbol resulting from the simultaneous transmission of a ‘source’ modulated symbol by said source entity and a ‘relay’ modulated symbol by the relay entity,
the ‘source’ modulated symbol corresponding to a point of a first constellation of order n,
the ‘relay’ modulated symbol corresponding to a point of a second constellation of order m,
the points of said first and second constellations all being separate,
the resulting symbol corresponding to a point of a constellation of order n+m, whose real component is obtained by summation of the real components of the points associated with said ‘source’ modulated symbol and said ‘relay’ modulated symbol and whose imaginary component is obtained by summation of the imaginary components of the points associated with the source modulated symbol and the ‘relay’ modulated symbol.
a demodulation step of said signal, supplying at least one ‘source’ code word representative of a ‘source’ modulated symbol corresponding to a point of said first constellation and at least one ‘relay’ code representative of a ‘relay’ modulated symbol corresponding to a point of said second constellation;
an iterative decoding step of said ‘source’ and ‘relay’ code words.

In this way, the reception method according to the invention makes it possible on reception of the signal previously described, to demodulate and decode jointly the ‘source’ and ‘relay’ modulated symbols sent respectively by the ‘source’ entity and ‘relay’ entity.

Indeed, the recipient entity receives a signal resulting from the superposition of the signals sent respectively by the source entity and relay entity.

As previously seen, such a signal comprises at least one symbol resulting from the simultaneous transmission of a ‘source’ modulated symbol by said source entity and a ‘relay’ modulated symbol by the relay entity,

According to a particular aspect, the demodulation step implements a demodulator with a demodulator order greater than or equal to the sum of the orders of modulation of the modulators used by the source entity and said at least one relay entity on transmission.

Indeed, owing to the fact that the signal received includes the symbols resulting from the simultaneous transmission of the source entity and the relay entity, the demodulator used to demodulate this resulting symbol and consequently perform a joint demodulation of the source entity and the relay entity is of the order greater than or equal to the sum of the orders of modulation of the modulators used by the source entity and relay entity.

Optimally, in terms of complexity, the order of the demodulator is exactly equal to the sum of the orders of modulations of the modulators used by the source entity and the relay entity.

However, it is also possible that a demodulator of order greater than the sum of the orders of modulation is used to demodulate the signal received at the cost of an increase in the complexity implemented.

In another embodiment, the invention also relates to a recipient entity able to receive a signal representative of an information sequence, sent by a source entity, via at least one relay entity. According to the invention, such a recipient entity comprises:

means for receiving said signal comprising, at least one symbol resulting from the simultaneous transmission of a ‘source’ modulated symbol by said source entity and a ‘relay’ modulated symbol by the relay entity,
the ‘source’ modulated symbol corresponding to a point of a first constellation of order n,
the ‘relay’ modulated symbol corresponding to a point of a second constellation of order m,
the points of the first and second constellations all being separate,
the resulting symbol corresponding to a point of a constellation of order n+m, whose real component is obtained by summation of the real components of the points associated with said ‘source’ modulated symbol and the ‘relay’ modulated symbol and whose imaginary component is obtained by summation of the imaginary components of the points associated with the ‘source’ modulated symbol and the ‘relay’ modulated symbol;
means for demodulating the signal, supplying at least one ‘source’ code word representative of a ‘source’ modulated symbol corresponding to a point of the first constellation and at least one ‘relay’ code representative of a ‘relay’ modulated symbol corresponding to a point of said second constellation;
iterative decoding means of the ‘source’ and ‘relay’ code words.

Such a recipient entity is notably adapted for implementing the reception method described previously.

The invention also relates to a system for transmitting an information sequence from a source entity to a recipient entity, via at least one relay entity,

Such a system comprises:
the source entity, sending modulated symbols representative of the information sequence, called ‘source’ modulated symbols, each ‘source’ modulated symbol corresponding to a point of a first constellation;
the at least one relay entity, sending modulated symbols representative of an estimation of the information sequence, called ‘relay’ modulated symbols, each ‘relay’ modulated symbol corresponding to a point of a second constellation,
the points of the first and second constellations all being separate,
   and in that the source entity and the at least one relay entity simultaneously send at least one of the ‘source’ modulated symbols and at least one of the ‘relay’ modulated symbols.

This cooperative system can naturally comprise the different characteristics relating to the transmission method according to the invention, which can be combined or taken separately. Hence, the characteristics and advantages of this system are the same as those of the transmission method. Consequently, they are not detailed more fully.

The invention also relates to a computer program comprising instructions for implementing a transmission or reception method described previously when this program is executed by a processor.

This program can use any programming language, and be in the form of source code, object code, or intermediate code between source code and object code, such as in a partially compiled form, or in any other desirable form.

### LIST OF FIGURES

Other characteristics and advantages of the invention will emerge more clearly upon reading the following description of a particular embodiment, provided as a simple illustrative non-restrictive example and referring to the annexed drawings, wherein:

FIG. 1 already described in relation to the prior art, illustrates the transmission of conventional co-operative systems,

FIG. 2 shows the mains steps of the transmission method according to the invention,

FIG. 3 illustrates the simultaneous transmission of the source entity and the relay entity according to the invention,

FIG. 4 is a diagrammatic representation of the transmission system according to the invention,

FIG. 5 is a diagrammatic representation of the transmission system according to the invention when two relay entities are taken into account for example,

FIGS. 6 to 9 show different combinations of constellations implemented respectively by the source entity and the relay entity, as well as the resulting constellation from the simultaneous emission of the source entity and the relay entity,

FIG. 10 shows the mains steps of the reception method according to the invention,

FIG. 11 is used to set up a comparison in terms of performances with and without cooperation of a relay entity according to the method of the invention.

### DETAILED DESCRIPTION OF AN EMBODIMENT OF THE INVENTION

### 6.1 General Principle

The general principle of the invention lies in the implementation of a breakdown of the coding and of the modulation of a symbol to transmit. More precisely, the coding and modulation of an information symbol to transmit is done in a distributed manner on at least one source entity and at least one relay entity that simultaneously transmits.

The resulting symbol of the simultaneous transmission of the relay entity and of the source entity corresponds to a point of a constellation of order n+m of the superposition of the signals respectively sent by the source entity and by the relay entity.

Through a choice of the ‘source’ and ‘relay constellations providing the uniqueness of the coordinates of each point of the resulting constellation of order n+m, it is thus possible at the receiver level to dissociate the original ‘source’ and ‘relay’ modulated symbols without interference.

Indeed, the signal sent by the source entity comprises symbols called ‘source’ modulated symbols, a ‘source’ modulated symbol being represented by a point of a first constellation of order n.

Further, the signal sent by the relay entity comprises symbols called ‘relay’ modulated symbols, a ‘relay’ modulated symbol being represented by a point of a second constellation of order m.

The points of the first and second constellations are furthermore all separate.

In the channel, the resulting signal is obtained from the fact of the superposition of the signals transmitted simultaneously by the source entity and by the relay entity intended for the recipient entity.

Owing to the correlation between the relay entity and the source entity, the relay entity sending a signal constructed from an estimation of the signal sent by the source entity, the constellation of a higher order implemented on the transmission according to the invention comes from two correlated transmitting entities that are further able to send simultaneously.

Hence, the resulting constellation obtained during the superposition of the signals sent simultaneously by the source entity and by the relay entity comes from the two additional constellations implemented by the source entity and by the relay entity.

Indeed, a point of the resulting constellation of order n+m, is characterised by a real part (respectively imaginary) equal to the sum of the real part (respectively imaginary) of a point of the first ‘source’ constellation of order n and of the real part (respectively imaginary) of a point of the second ‘relay’ constellation of order m.

Hence, the invention is based on a complementarity of the source entity and of the relay entity so as to increase the spectral efficiency of transmission by preventing any risk of interference.

### 6.2 Description of an Embodiment of the Transmission Method According to the Invention

In relation to FIG. 2, the main steps of the transmission method according to a first embodiment of the invention are presented.

This description of an embodiment taking into account a source entity (S), a relay entity (R) and a recipient entity (D), can also be transposed in the multiple source or even multiple relay case (as subsequently described with regard to FIG. 4).

According to a first step of the method according to the invention, a transmission step (21) is implemented, by the source entity, of modulated symbols representative of the information sequence, called ‘source’ modulated symbols, each ‘source’ modulated symbol (Ss) corresponding to a point of a first constellation (C1), of order n.

With regard to FIGS. 6 to 9 representing different examples of constellations (C1) of order n used by the source entity, the ‘source’ points are represented by ‘x’ signs.

More precisely, the transmission step of ‘source’ modulated symbols (Ss) comprises a sub-step (211) for coding the information sequence, supplying at least one ‘source’ code word, and a sub-step (212) for modulating this ‘source’ code word, supplying the ‘source’ modulated symbols (Ss).

In parallel to the source entity (S), with the exception of the first transmission made by the source entity, the relay entity also implements a simultaneous transmission step (22) of modulated symbols representative of an estimation (E) of said information sequence, said ‘relay’ modulated symbols (Sr), each ‘relay’ modulated symbol corresponding to a point of a second constellation (C2), of order m.

With regard to FIGS. 6 to 9 representing different examples of constellations (C1) of order n used by the source entity, the ‘relay’ points are represented by ‘+’ signs.

More precisely, the transmission step of ‘relay’ modulated symbols (Sr) comprises a sub-step (221) for decoding ‘source’ modulated symbols after reception (not shown) of said symbols, supplying an estimation (E) of the information sequence, a sub-step (222) for coding the estimation of said information sequence, supplying at least one ‘relay’ code word, and a sub-step (223) for modulating the at least one ‘relay’ code word, supplying the ‘relay’ modulated symbols (Sr).

As described subsequently with regard to FIGS. 6 to 9, the invention is characterised by the fact that the points of the first and second constellations (C1 and C2) being all separate, and by the fact that the source entity (S) and the relay entity (R) simultaneously transmit in the channel H (except for the first transmission made by the source entity) at least one of the ‘source’ modulated symbols (Ss) and at least one of said ‘relay’ modulated symbols (Sr).

Owing to the fact of the simultaneous transmission of the source entity (S) and the relay entity (R), in the channel H the resulting symbols (Sd) are obtained by superposition corresponding to a point of a constellation (Ceq) of order n+m resulting from the superposition of the signals respectively sent by the source entity (S) and by the relay entity (R).

A point of the resulting constellation (Ceq) of order n+m, is characterised by a real part (respectively imaginary) equal to the sum of the real part (respectively imaginary) of a point of the first ‘source’ constellation of order n and of the real part (respectively imaginary) of a point of the second ‘relay’ constellation of order m.

Examples of resulting constellations will notably be shown subsequently with FIGS. 6 to 9.

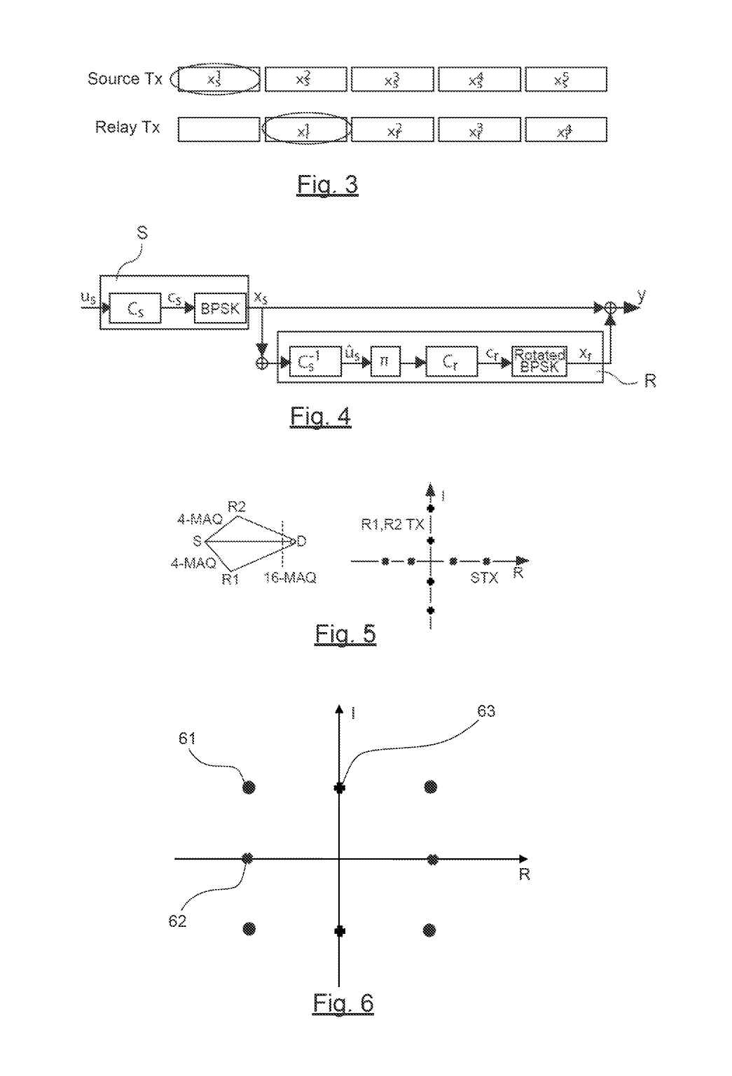

FIG. 3 notably illustrates the simultaneous transmission of the source entity and the relay entity according to the invention. Indeed, with regard to this figure, the source entity and relay entity transmit simultaneously. The relay entity indeed transmits a coded version of the information of the source entity received in the previous unit of time. There is therefore an offset of one unit of time between the simultaneous transmissions of a relay entity and a source entity.

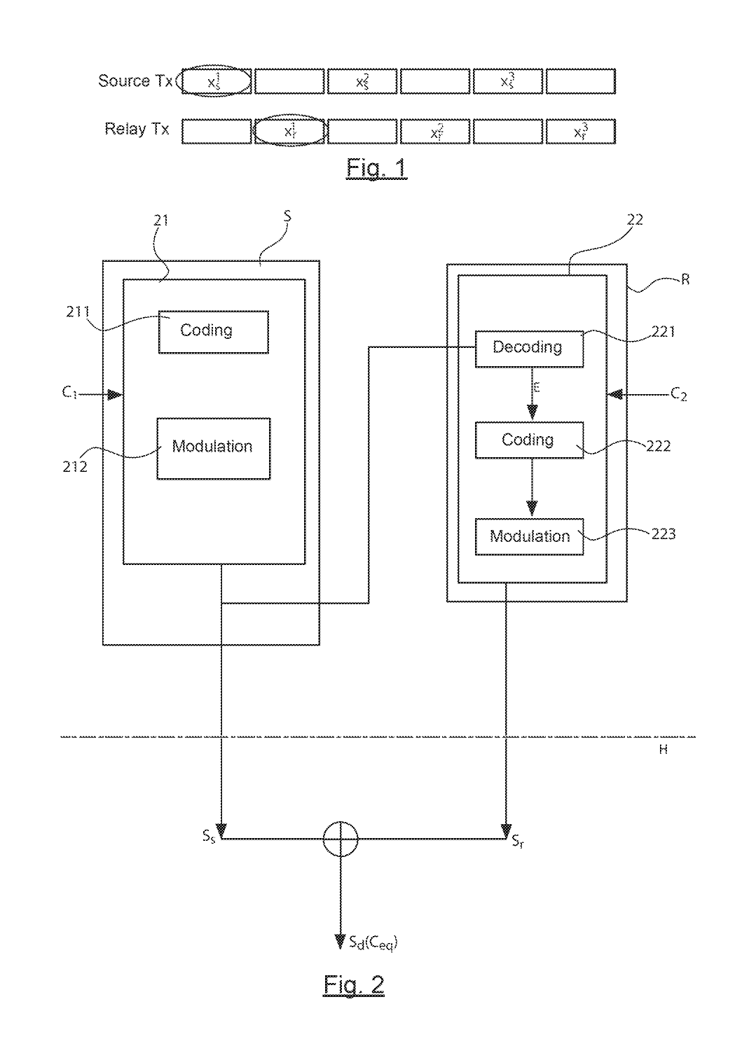

Hence, the comparison of FIG. 1 previously compared with regard to the prior art and to FIG. 3 illustrating the simultaneous transmission according to the invention, it is possible to note that according to the invention, there is indeed for a considered unit of time (except for the first considered as an initialisation step of the method according to the invention) a simultaneous transmission of the source entity and the relay entity.

Hence according to the invention, a quantity of information two times greater is transmitted per unit of time with regard to the prior art described in relation to FIG. 1.

The spectral efficiency is therefore strongly optimised according to the method of the invention.

Furthermore, by transposition of the general principle of this invention, a multiple source and/or multiple relay system implements as many simultaneous transmissions as there are source entities and relay entities in the transmission system considered.

According to this type of transmission system according to the invention, the spectral efficiency is therefore enhanced even further.

### 6.3 Physical Implementation of the Transmission Method According to the Invention

FIG. 4 corresponds to a diagrammatic representation of the transmission system according to an embodiment of the invention implementing the steps of the method according to the invention previously described in relation to FIG. 2.

Indeed, according to the example shown in FIG. 4, a information sequence uₛ of length kₛ bits is coded (211) into code word cₛ within the source entity S by a coder C. of efficiency Rₛ. The code word cₛ is then modulated (212) into xₛ and transmitted on channel H.

In the example of FIG. 4, we notably consider a modulation of order n=1 of the BPSK type (binary phase shift keying) whose constellation C1 is represented by the “x” points in FIG. 6.

Next, with regard to FIG. 4, the relay entity receives a noisy version of the code word (cₛ, y_{S,R}). This noisy code word is decoded (221) within the relay entity R by a decoder Cₛ⁻¹ of efficiency Rₛ supplying an estimation ûₛ.

The estimation uₛ is then interleaved by an interleaver H aiming to add redundancy, then re-encoded (222) by a coder Cᵣ of efficiency Rₛ into code word cᵣ.

The coder Cᵣ of the relay entity can be according to a first variant different or according to a second variant identical to the coder Cₛ implemented within the source entity, which provides great flexibility of implementation.

It is thus possible to combine source entities and existing relay entities can import the coding that they implement respectively.

The code word cᵣ is then modulated (223) by using a modulation according to a constellation C2 whose points are separate from constellation C1 used by the modulator of the source entity. In the example of FIG. 4, we notably consider a modulation of order m=1 of the BPSK type (binary phase shift keying) whose constellation C2 is represented by the “+” points in FIG. 6. Hence, with regard to the first constellation C1 used by the source entity, the second constellation C2 used by the relay entity corresponds to the constellation C1 rotated by an angle φ. In the example according to FIG. 6, constellations C1 and C2 are phase shifted by an angle φ=90°, in other words the second constellation C2 is a rotation of a quarter turn of the first constellation C1.

Hence, according to this example, the modulations implemented on the one hand by the source entity and implemented on the other by the two relay entities are respectively quadrature and phase modulations.

According to the invention other values of φ can be used. Different value examples of φ are notably illustrated by FIGS. 7 to 9 described subsequently.

Hence, seen by the recipient entity, the equivalent modulation (Ceq) distributed on the source entity and the relay entity is a modulation of order 2 (1+1) comprising 2²=4 points of the QPSK type represented by the constellation (Ceq) whose points are “O” in FIG. 6.

This “distribution” of the modulation on the source entity and the relay entity notably enable a robust “source-relay” link to be kept owing to the fact that a modulation of a lower order n with regard to the equivalent modulation of order n+m is used between the source entity and the relay entity.

According to this example, the modulation implemented by the source entity corresponds to the modulation on the axis of the real values, whereas the modulation implemented by the relay entity corresponds to the modulation on the axis of the imaginary values.

A resulting symbol (Sd) corresponds to a point 61 of the constellation (Ceq) of order 4 of type QPSK, whose real component (respectively imaginary) is equal to the sum of the real component (respectively imaginary) of an ‘x’ point 62 of the first ‘source’ constellation C1 of order n=1 of type BPSK and of the real component (respectively imaginary) of a ‘+’ point 63 of the second ‘relay’ constellation C2 of order m=1 of type BPSK.

### 6.4 Description of a Multiple Relay System According to the Invention

FIG. 5 diagrammatically shows a transmission system according to the invention when two relay entities (R1 and R2) are taken into account for example.

Such a multiple relay system is an obvious transposition of the general principle of this invention.

According to this transmission system, the source entity S transmits in the direction of the two relay entities R1 and R2 and also directly in the direction of the recipient entity D. Indeed, the direct transmission of the source entity to the recipient notably enables a transmission to be made from the source entity to the recipient notably in the case of an operating fault (failure, discharged battery, destruction) of the relay entity.

In the system shown in FIG. 5, the source entity notably sends a ‘source’ modulated symbol (Ss) by using a constellation C1 of the modulation type of order n=2 with four amplitude states (points) (MA-4) for each relay entity (R1) and (R2) shown by ‘x’ points on this same figure. The relay entities R1 and R2 respectively send a ‘relay’ modulated symbol (Sr) by using a constellation C2 of the amplitude modulation type of order n=2 with four amplitude states (points) (MA-4) for the recipient entity shown by ‘+’ points on this same figure. The constellation C2 used by the relay entities being rotated by an angle φ=90° in relation to the constellation C1. Hence, according to this example, the modulations implemented on the one hand by the source entity and implemented on the other by the two relay entities are respectively quadrature and phase modulations.

Hence, a point P1 (62) of C1 having for coordinates (a=−1, and b=0) corresponds to a point P2 (63) of c2 having for coordinates (a′=a*e^{jφ}=0, and b′=b*e^{jφ}=1), the resulting point PR (61) in the equivalent constellation has for coordinates (a″=a′+a=−1, and b″=b′+b=1).

Hence, the second constellations C2 used by each relay entity have separate points from the first constellation C1 used by the source entity. The equivalent constellation (Ceq) observed by the recipient entity (D) corresponds to a constellation of type 16 MAQ corresponding to a quadrature amplitude modulation of order 4.

According to an embodiment variant (not shown), the relay entities R1 and R2 can also use constellations C2 and C2′ the points of which would be separate from one ‘relay’ constellation C2 to the other ‘relay constellation C2’ and also separate from the ‘source’ constellation C1.

### 6.5 Examples of Distributed Modulations According to the Invention

FIGS. 7 to 9 illustrate on the one hand other constellations used respectively by the relay entity and by the source entity and the resulting constellation of each of these combinations.

According to these representations, the points of the ‘source’ constellations are shown by ‘x’, the points of the ‘relay’ constellations are shown by ‘+’ and the points of the resulting constellations of the simultaneous transmission of the source entity and relay entity are shown by ‘O’.

FIG. 7 notably corresponds to the modulation distribution previously described in relation to FIG. 5, the resulting constellation of order 4 of type 16-MAQ comprises sixteen points.

The real component (respectively imaginary) of each of these 16 points is equal to the sum of the real component (respectively imaginary) of an ‘x’ point of the first ‘source’ constellation C1 of order n=2 of type MA-4 and of the real component (respectively imaginary) of a ‘+’ point of the second ‘relay’ constellation C2 of order m=2 also of type MA-4.

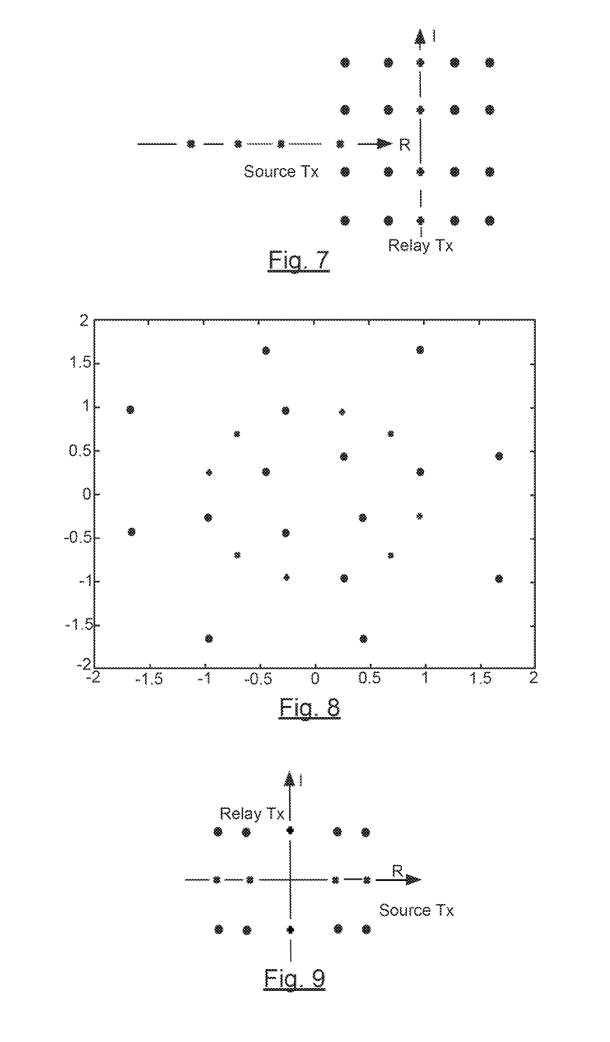

For its part, FIG. 8 illustrates another example according to which the source entity and the relay entity use two constellations C1 and C2 of order n=m=2 of type QPSK. According to the invention, the constellation C2 implemented by the relay entity is a rotation of an angle φ=30° of the constellation C1 implemented by the relay entity.

Hence, according to this example, the modulations implemented on the one hand by the source entity and on the other by the relay entity are not quadrature and phase modulations as shown in the previously described examples.

The coordinates of the points of the constellations C1 are C2 are shown below:

C2

| | |
|---|---|
| −0.96 | 0.26 |
| 0.26 | 0.96 |
| 0.96 | −0.26 |
| 0.26 | −0.96 |

C1

| | |
|---|---|
| −0.7 | 0.7 |
| 0.7 | 0.7 |
| 0.7 | −0.7 |
| −0.7 | −0.7 |

Hence, the coordinates of the 16 points of the equivalent constellation of order n+m=4 obtained during the simultaneous transmission of the source entity and of the relay entity are:

Ceq

| | |
|---|---|
| −1.66 | 0.96 |
| −0.44 | 1.66 |
| 0.26 | 0.44 |
| −0.96 | −0.26 |
| −0.26 | 0.96 |
| 0.96 | 1.66 |
| 1.66 | 0.44 |
| 0.44 | −0.26 |
| −0.26 | −0.44 |
| 0.96 | 0.26 |
| 1.66 | −0.96 |
| 0.44 | −1.66 |
| −1.66 | −0.44 |
| −0.44 | 0.26 |
| 0.26 | −0.96 |
| −0.96 | −1.66 |

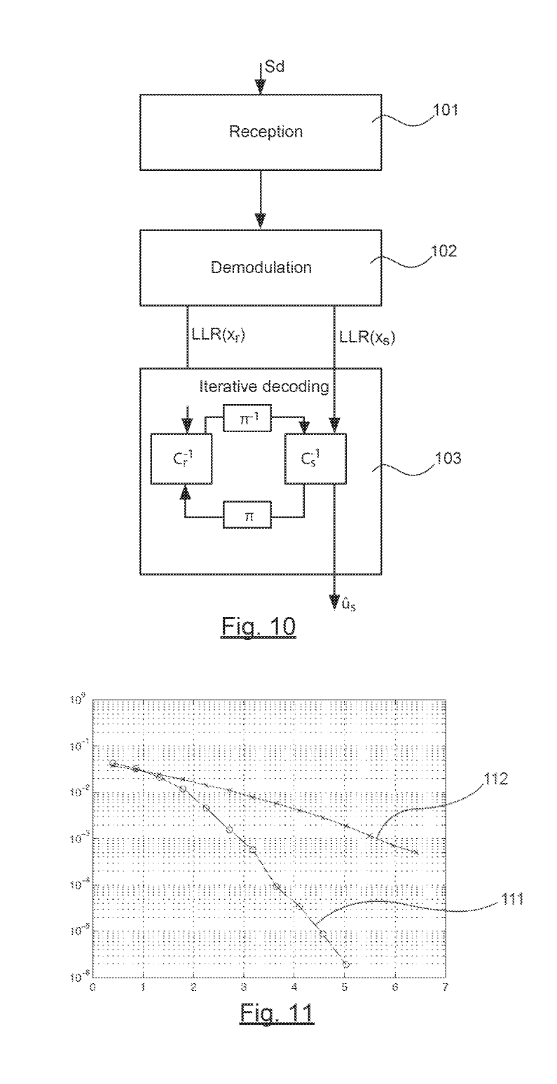

FIG. 9 illustrates another example according to which the source entity and the relay entity use two constellations C1 and C2 of different orders that is n=2 for the source entity and m=1 for the relay entity.

According to this example, the modulations implemented on the one hand by the source entity and on the other by the relay entity are respectively quadrature and phase modulations. Further, the modulation implemented by the source entity corresponds to the modulation on the axis of the real values, whereas the modulation implemented by the relay entity corresponds to the modulation on the axis of the imaginary values.

Hence, seen by the recipient entity, the equivalent modulation (Ceq) distributed on the source entity and the relay entity is a modulation of order 3 (2+1) comprising 2³=8 points represented by the constellation (Ceq) whose points are “O” in FIG. 9.

### 6.6 Description of an Embodiment of the Reception Method According to the Invention

In relation to FIG. 10, the main steps of the reception method according to an embodiment of the invention are presented.

The recipient entity simultaneously receives (101) the signals from the source entity and from the relay entity and jointly decodes iteratively (103) the information of the source entity by using the additional redundancy of the relay entity.

More precisely, after reception, the recipient entity implements a demodulation (102) by means of a demodulator having an order of demodulation greater than or equal to the sum of the orders of modulation used by the at least one source entity and the at least one relay entity in transmission of the previously described transmission system.

Optimally, the order of the demodulator is exactly equal to the sum of the orders of modulations of the modulators used to prevent any additional processing complexity.

Such a demodulator jointly demodulates the signals received from the source entity and from the relay entity to generate for example log-likelihood ratios (LLRs) LLR(xₛ) and LLR(xᵣ).

For example, for two BPSK modulations used in transmission by the source entity and the relay entity, the points of the constellations used respectively by the source entity and the relay entity all being separate, the demodulator used is a demodulator of order n+m=2 of the QPSK type.

Owing to the specific construction of the resulting equivalent constellation of the superposition of signals transmitted simultaneously by the source entity and by the relay entity as previously described, the demodulator easily separates the ‘source’ modulated symbols from the ‘relay’ modulated symbols.

Indeed, as previously described, the resulting equivalent constellation in the simultaneous transmission channel of the source entity and of the relay entity is a constellation of order n+m=2.

The log-likelihood ratios (LLRs) LLR(xₛ) and LLR(xᵣ) are supplied by the demodulator respectively at the input of the decoders Cₛ⁻¹ and Cᵣ⁻¹the decoders Cₛ and Cᵣ corresponding respectively to the coders Cₛ and Cᵣ.

The joint decoding (103) of the information of the source entity uₛ is an iterative decoding by exchange of extrinsic information between the decoders Cₛ⁻¹ and Cᵣ⁻¹.

It must be noted that taking into account the offset introduced from the start in the transmission diagram so as to leave time for the relay entity to decode the stream coming from the source entity must be integrated into the iterative decoding process. This means simply that the iterative decoding will be done by crossing the extrinsic information from two consecutive code words and not those from two simultaneous code words. This does not increase the complexity of the decoding and only introduces a latency during the decoding.

### 6.7 Performances of the Method According to the Invention

The method according to the invention is used to achieve good performances in terms of minimisation of the bit error rate. Indeed, the graph of FIG. 11 is a superposition of the pulse responses of the channel with (111) and without (112) processing, in other words without relay entity, according to the transmission cooperative method of the invention,

These performance results are notably obtained by considering, for the implementation of the method according to the invention, that the source entity and the relay entity use a recursive 4-state convolutional code of efficiency R=½ and a BPSK modulation, applied to an information sequence uₛ of length kₛ=128 bits with ten decoding iterations.

However, as we have seen previously different types of coding with different efficiencies can be used respectively by the relay entity and the source entity.

To be comparable, the performance results of the method according to the invention are compared to the simulation case where a source entity uses an efficiency code R=¼ and a QPSK modulation.

With regard to FIG. 11, the performances in terms of BER (bit error rate) are tracked according to the signal ratio γ_{sd} the signal to noise ratio of the channel between the source entity and the recipient entity.

Furthermore, the channels used according to the simulation shown in FIG. 11 are rapid Rayleigh fading channels.

It is noted that the method according to the invention enables a large gain to be obtained in terms of bit error rate in relation to a direct transmission (112) between the source entity and the recipient entity.

For example, a gain of around 3 dB is obtained for a bit error rate of 10⁻³.

Although the present disclosure has been described with reference to one or more examples, workers skilled in the art will recognize that changes may be made in form and detail without departing from the scope of the disclosure and/or the appended claims.

1. A transmission method of an information sequence from at least one source entity to a recipient entity, via at least one relay entity, wherein the method comprises:
transmitting, by said at least one source entity, modulated symbols representative of said information sequence, called ‘source’ modulated symbols, each ‘source’ modulated symbol corresponding to a point of a first constellation of order n;
transmitting, by said at least one relay entity, modulated symbols representative of an estimation of said information sequence, called ‘relay’ modulated symbols, each ‘relay’ modulated symbol corresponding to a point of a second constellation, of order m.
the points of said first and second constellations all being separate,
and wherein said at least one source entity and said at least one relay entity simultaneously send at least one of said ‘source’ modulated symbols and at least one of said ‘relay’ modulated symbols.

2. The transmission method according to claim 1, transmitting the ‘source’ modulated symbols comprises coding said information sequence, supplying at least one ‘source’ code word, and modulating said at least one ‘source’ code word, supplying said ‘source’ modulated symbols,
and wherein transmitting the ‘relay’ modulated symbols comprises: decoding said ‘source’ modulated symbols, supplying said estimation of said information sequence; coding said estimation of said information sequence, supplying at least one ‘relay’ code word; and modulating said at least one ‘relay’ code word, supplying said ‘relay’ modulated symbols.

3. The transmission method according to claim 2, wherein said for coding said information sequence and coding said estimation of said information sequence implement separate coding methods.

4. The transmission method according to claim 2, wherein modulating said at least one ‘source’ code word and modulating said at least one ‘relay’ code word implement separate modulation methods.

5. The transmission method according to claim 2, wherein modulating said at least one ‘source’ code word and modulating said at least one ‘relay’ code word are respectively quadrature and phase modulations.

6. (canceled)

7. A source entity configured to send an information sequence to a recipient entity, via at least one relay entity, wherein the source entity comprises:
a transmitter configured to transmit modulated symbols representative of said information sequence, called ‘source’ modulated symbols, each ‘source’ modulated symbol corresponding to a point of a first constellation;
said transmission means being configured to send at least one of said ‘source’ modulated symbols simultaneously to at least one ‘relay’ modulated symbol representative of an estimation of said information sequence, each ‘relay’ modulated symbol corresponding to a point of a second constellation,
the points of said first and second constellations all being separate.

8. A relay entity configured to receive, from at least one source entity, at least one ‘source’ modulated symbol representative of an information sequence, each ‘source’ modulated symbol corresponding to a point of a first constellation, and to send again said information sequence to a remote entity,
a transmitter configured to transmit ‘relay’ modulated symbols representative of an estimation of said information sequence, each ‘relay’ modulated symbol corresponding to a point of a second constellation,
transmitter being configured to send at least one of said ‘relay’ modulated symbols simultaneously to at least one of said ‘source’ modulated symbols,
the points of said first and second constellations all being separate.

9. A reception method of a signal representative of an information sequence, sent by a source entity, via at least one relay entity. wherein the method comprises:
receiving said signal comprising, at least one symbol resulting from a simultaneous transmission of a ‘source’ modulated symbol by said source entity and a ‘relay’ modulated symbol by said relay entity,
said ‘source’ modulated symbol corresponding to a point of a first constellation of order n,
said ‘relay’ modulated symbol corresponding to a point of a second constellation of order m,
the points of said first and second constellations all being separate,
said resulting symbol corresponding to a point of a constellation of order n+m, whose real component is obtained by summation of the real components of the points associated with said ‘source’ modulated symbol and said ‘relay’ modulated symbol and whose imaginary component is obtained by summation of the imaginary components of the points associated with the source modulated symbol and the ‘relay’ modulated symbol;
demodulating said signal, supplying at least one ‘source’ code word representative of a ‘source’ modulated symbol corresponding to a point of said first constellation and at least one ‘relay’ code representative of a ‘relay’ modulated symbol corresponding to a point of said second constellation; and
iteratively decoding said ‘source’ and ‘relay’ code words.

10. The reception method according to claim 9, wherein demodulating implements a demodulator with a demodulator order greater than or equal to the sum of the orders of modulation of the modulators used by said at least one source entity and said at least one relay entity on transmission.

11. A recipient entity configured to receive a signal representative of an information sequence, sent by at least one source entity, via at least one relay entity, it wherein the recipient entity comprises:
means for receiving said signal comprising, at least one symbol resulting from the simultaneous transmission of a ‘source’ modulated symbol by said source entity and a ‘relay’ modulated symbol by said relay entity,
said ‘source’ modulated symbol corresponding to a point of a first constellation of order n,
said ‘relay’ modulated symbol corresponding to a point of a second constellation of order m,
the points of said first and second constellations all being separate,
said resulting symbol corresponding to a point of a constellation of order n+m, whose real component is obtained by summation of the real components of the points associated with said ‘source’ modulated symbol and said ‘relay’ modulated symbol and whose imaginary component is obtained by summation of the imaginary components of the points associated with the source modulated symbol and the ‘relay’ modulated symbol;
means for demodulating said signal, supplying at least one ‘source’ code word representative of a ‘source’ modulated symbol corresponding to a point of said first constellation and at least one ‘relay’ code representative of a ‘relay’ modulated symbol corresponding to a point of said second constellation;
means for iteratively decoding said ‘source’ and ‘relay’ code words.

12. A transmission system of an information sequence from at least one source entity to a recipient entity, via at least one relay entity wherein the system comprises:
said at least one source entity, which is configured to send modulated symbols representative of said information sequence, called ‘source’ modulated symbols, each ‘source’ modulated symbol corresponding to a point of a first constellation;
said at least one relay entity, which is configured to send sending modulated symbols representative of an estimation of said information sequence, called ‘relay’ modulated symbols, each ‘relay’ modulated symbol corresponding to a point of a second constellation,
the points of said first and second constellations all being separate,
and wherein said at least one source entity and said at least one relay entity are configured to simultaneously send at least one of said ‘source’ modulated symbols and at least one of said ‘relay’ modulated symbols.

13. A non-transitory computer-readable medium comprising a computer program stored thereon and comprising instructions for implementing a method to transmit an information sequence from at least one source entity to a recipient entity, via at least one relay entity, when this program is executed by a processor, wherein the method comprises:
transmitting, by said at least one source entity, modulated symbols representative of said information sequence, called ‘source’ modulated symbols, each ‘source’ modulated symbol corresponding to a point of a first constellation, of order n;
wherein the transmitting by said source entity comprises transmitting at least one of said ‘source’ modulated symbols simultaneously with a transmission by said relay entity of at least one of a plurality of ‘relay’ modulated symbols, which are representative of an estimation of said information sequence, wherein each ‘relay’ modulated symbol corresponds to a point of a second constellation, of order m, the points of said first and second constellations all being separate.

14. A non-transitory computer-readable medium comprising a computer program stored thereon and comprising instructions for implementing a method to receive a signal representative of an information sequence, sent by a source entity, via at least one relay entity, when this program is executed by a processor, wherein the method comprises:
receiving said signal comprising, at least one symbol resulting from a simultaneous transmission of a ‘source’ modulated symbol by said source entity and a ‘relay’ modulated symbol by said relay entity,
said ‘source’ modulated symbol corresponding to a point of a first constellation of order n,
said ‘relay’ modulated symbol corresponding to a point of a second constellation of order m,
the points of said first and second constellations all being separate,
said resulting symbol corresponding to a point of a constellation of order n+m, whose real component is obtained by summation of the real components of the points associated with said ‘source’ modulated symbol and said ‘relay’ modulated symbol and whose imaginary component is obtained by summation of the imaginary components of the points associated with the source modulated symbol and the ‘relay’ modulated symbol;
demodulating said signal, supplying at least one ‘source’ code word representative of a ‘source’ modulated symbol corresponding to a point of said first constellation and at least one ‘relay’ code representative of a ‘relay’ modulated symbol corresponding to a point of said second constellation; and
iteratively decoding said ‘source’ and ‘relay’ code words.
